(19) United States
(12) Patent Application Publication
(10) Pub. No.: US 2008/0229511 A1
(43) Pub. Date: Sep. 25, 2008

(54) Process for the Preparation of Synthetic Tanning Agent for Improved Leather Characteristics

(75) Inventors: Natraj Rajendran, Chennai (IN); Saravanabhavan Subramani, Chennai (IN); Aravindhan Rathinam, Chennai (IN); Janardhanan Sreeram Kalarical, Chennai (IN); Raghava Rao Jonnalagadda, Chennai (IN); Unni Nair Balachandran, Chennai (IN); Ramasami Thirumalachari, Chennai (IN)

Correspondence Address: FULBRIGHT & JAWORSKI L.L.P., 600 CONGRESS AVE., SUITE 2400, AUSTIN, TX, 78701, US

(73) Assignee: COUNCIL OF SCIENTIFIC & INDUSTRIAL RESEARCH, New Delhi (IN)

(21) Appl. No.: 11/877,878

(22) Filed: Oct. 24, 2007

(30) Foreign Application Priority Data
Mar. 23, 2007 (IN) 648/DEL/2007

(51) Int. Cl. C14C 3/08

(52) U.S. Cl. 8/94.33

(57) ABSTRACT

Generally, the tanned leathers are retanned with a combination of synthetic tanning agents to enhance the properties such as fullness, grain tightness, grain smoothness and roundness. Many of the chemicals that go into the preparation of such synthetic tanning agents are toxic and slow biodegradable. Further, in industrial practice, several synthetic tanning agents are combined to obtain a desired property. In the present invention, a synthetic tanning agent using natural and proteinous waste materials is disclosed, which provides to the leather the properties such as better fibre lubrication, filling of looser ends, softness, shape retention and fabrication comforts without combining with other synthetic tanning agents is reported.

### BACKGROUND OF THE INVENTION

1. Field of the Invention

The present invention relates to a process for the preparation of synthetic tanning agent for improved leather characteristics. More particularly, the present invention provides a process for the manufacture of synthetic tanning agent for improved leather characteristics prepared from natural and proteinous solid materials. It is envisaged to have potential application in leather industry for making leathers, whereby the combination of synthetic tanning agents can be substituted in the conventional post tanning operation by a single synthetic tanning agent.

2. Description of Related Art

Post tanning operation, in general, attempt the addition of aesthetic values and improvement of functional properties of leather (Fred O'Flaherty, Roddy, T. W. and Lollar, R. M. ‘The Chemistry and Technology of Leather, Vol II, Type of tannages’, Rober E. Krieger Publishing Co, Florida, 1978). Retanning, dyeing and fatliquoring are the major steps of post tanning operations (Eckhart Heidemann. Fundamentals of Leather Manufacture, Roetherdruck, Darmstadt Eduard Roether KG Cop, 1993). Leather is a crosslinked three-dimensional anisotropic collagen fiber network, functional properties of which vary from location to location. The market value of the leather lies on the profitable utilization of its area. Orientation and compaction of collagen fiber are the main determining factors for over all performance of the final leather. Hence, the application of suitable polymeric materials as synthetic tanning agents in post tanning operation can alter the determining factors.

Generally, the tanned leathers are retanned with a combination of synthetic tanning agents to enhance the properties such as fullness, grain tightness, grain smoothness and roundness. Synthetic tanning agents primarily employ condensates of phenol, naphthalene, urea, melamine, low molecular weight acrylic resins and polyamides as raw materials. The functional characteristics of leather are based on the type of synthetic tanning agent employed in the post tanning. Phenol-formaldehyde condensates based synthetic tanning agent provide uniform filling in all regions of leather. Synthetic tanning agents based on acrylics result in grain tightness and selective filling of the looser areas of leather. The use of natural materials such as vegetable tannins, lignin and polysaccharides enhances the overall filling and grain characteristics. Combination of synthetic tanning agents comprising of phenol-formaldehyde, acrylics and natural materials are employed to obtain functional properties in leathers as mentioned above. Many of these chemicals are toxic and slow biodegradable and hence affect the environment significantly.

Acrylic based tanning and retanning systems have been reported (U.S. Pat. No. 2,205,882 and U.S. Pat. No. 2,205,883). The disadvantages of acrylic products are that they considerably lighten the color of the leather and, when too large an amount is used, lead to a rubber-like feel of the leather. In order to avoid this, acrylics may also be grafted onto water-soluble proteins or polysaccharides. Such acrylic synthetic tanning agents have been prepared by graft polymerization of acrylic acid and methacrylic acid onto a mixture of sulfated fish oil and alginic acid by Lakshminarayana et al (Journal of the American Leather Chemists Association, 85, 425, 1990). Acrylic based retanning agents containing protein hydrolysates obtained from solid wastes like leather shavings, as a component of polymerization have also been reported by Kanagaraj et al (Journal of the American Leather Chemists Association, 97, 207, 2002) Further, acrylic acid modified products based on chitosan, alginic acid etc. are biodegradable and find use in bone implants and drug delivery systems as reported by Berger et al (European Journal of Pharmaceutics and Biopharmaceutics, 57, 19, 2004). Alginates, a natural biopolymer obtained from seaweeds, find its application in pharmaceutical, food, textile, polymer and leather industries. Graft co-polymer of acrylics and alginate have been reported as a retanning as well as chrome exhaustive aid in leather processing by Venba et al (Science and Technology for Leather into the Next Millennium, Tata McGraw-Hill Publishing Company Ltd., New Delhi, p. 220, 1999). The use of protein hydroylsates in leather processing as filling agent during post tanning has been reported by Chen et al (Journal of American Leather Chemists Association, 96, 262, 2001) and as chrome exhaust aid by Ramamurthy et al (Journal of the Society of Leather Technologists and Chemists, 73, 168, 1989).

However, no attempt has been made for the preparation of a synthetic tanning agent using natural and proteinous waste materials, which provide desired properties such as better fibre lubrication, filling of looser ends, softness, shape retention and fabrication comforts without combining with other synthetic tanning agents.

### SUMMARY OF THE INVENTION

The main objective of the present invention is thus to provide a process for the preparation of synthetic tanning agent, which by itself provides improved leather characteristics without combining with other synthetic tanning agents.

Yet another objective of the present invention is to provide a process for the preparation of a biodegradable synthetic tanning agent.

Still another objective of the present invention is to replace toxic chemicals such as phenol and formaldehyde used in the tanning process.

Yet another objective of the present invention is to prepare a synthetic tanning agent with low neutral salt content.

Still another objective of the present invention is to use biopolymers like alginates, starch, and carrageenan for tanning leather.

Yet another objective of the invention is use of proteins, preferably as their hydrolysates from the proteinous wastes of leather industry in tanning.

Still another objective of the present invention is the complexation/cross-linking of the product through in situ polymerization reactions with acrylic or methacrylic acid.

Accordingly, the present invention provides a tanning composition useful for tanning leathers comprising of a biopolymer, protein hydrolysate and sodium metabisulphite optionally along with acrylic/methacrylic acid.

The invention further provides a process for the preparation of the said tanning agent, which comprises:
[a] dissolution of the biopolymer in water under continuous stirring until a homogeneous viscous solution is obtained;
[b] simultaneous preparation of protein hydrolysate from proteinous waste materials by subjecting it to alkaline or enzymatic hydrolysis;
[c] blending of biopolymer solution as obtained from step [a], protein hydrolysate as obtained from step [b] and sodium metabisulphite under continuous stirring along with drop wise addition of acrylic/methacrylic acid and potassium persulphate;
[d] optionally neutralizing the blend as obtained from step [c] to pH 4.5 to 5.0 using alkali to obtain the desired tanning composition.

In an embodiment of the present invention, the biopolymer used for the preparation of synthetic tanning agent may be such as sodium alginate, starch and carrageenan either alone or in combination.

In another embodiment of the present invention, the amount of biopolymer used for the preparation of synthetic tanning agent may be in the range of 0.5 to 10 grams of product per 100 ml of water employed.

In yet another embodiment of the present invention, the amount of protein hydrolysate used for the preparation of synthetic tanning agent may be in the range of 10-25 grams of product per 100grams of biopolymer employed.

In another embodiment of the present invention, the amount of acrylic/methacrylic acid used for the preparation of synthetic tanning agent is about 10 ml per 100 mL of water used.

In still another embodiment of the present invention, the alkali used for the neutralization of synthetic tanning agent may be such as sodium carbonate, sodium bicarbonate, sodium hydroxide.

In yet another embodiment of the present invention, the amount of alkali used for the preparation of synthetic tanning agent may be in the range of 0.5-2 grams per 100 ml of acrylic acid employed.

### DESCRIPTION OF ILLUSTRATIVE EMBODIMENTS

The process of the present invention is described below in detail.

Solutions of biopolymer such as sodium alginate, starch and carrageenan in the concentration range of 0.5-10% is prepared using water at a temperature of 80° C. in a thermostatic three necked reactor. To this 10-25% w/w protein hydrolysate (based on the weight of the biopolymer) from proteinous wastes such as chrome shavings and raw hide trimming is added and then stirred for 10 min. Subsequently, 1% w/w sodium metabisulfite (based on the weight of the acrylic acid) is added to the reactor and stirred for 5 min. Acrylic acid dissolved in 400% v/v water (based on the weight of the acrylic acid) and 2% w/v potassium persulfate (based on the weight of the acrylic acid) dissolved in 3000% v/w water (based on the weight of the potassium persulfate) are added into the reactor simultaneously through two different necks of the reactor and stirred for 30 min. Finally, the viscous solution is stirred for 30 min. at 60° C. and then at 70° C. for 30 min. or till such time the product was devoid of any monomer smell. The resultant product is cooled to room temperature. The cooled solution is neutralized to a pH 4.5-5.0 using 0.5-2% w/v alkali or mixture of alkalis (based on the weight of the acrylic acid) with continuous stirring if required.

The inventive step of the present invention lies in the preparation of a synthetic tanning agent by blending the solution of biopolymer, protein hydrolysate, sodium metabisulphite and simultaneous addition of acrylic acid and potassium persulphate under continuous stirring. The product thus obtained provides improved properties to the final leather.

The invention is described in detail in the following examples, which are provided by way of illustration only and therefore should not be construed to limit the scope of the present invention.

### EXAMPLE 1

In a thermostatic three-necked reactor, 12.5 grams of sodium alginate was dissolved in 2500 ml water at a temperature of 80° C. To this 3.1 g protein hydrolysate (based on the weight of the biopolymer) from proteinous wastes was added and stirred for 10 min. Subsequently, 5 grams sodium metabisulfite (based on the weight of the acrylic acid) was added to the reactor and stirred for 5 min. 500 ml acrylic acid dissolved in 2000 ml water (based on the weight of the acrylic acid) and 10 grams potassium persulfate (based on the weight of the acrylic acid) dissolved in 300 ml water (based on the weight of the potassium persulfate) were added into the reactor simultaneously through two different necks and stirred for 30 min. Finally, the viscous solution was stirred for 30 min. at 60° C. and then at 70° C. for 30 min. The resultant product, devoid of monomer smell was cooled to room temperature. The product was finally neutralized to a pH 5.0 using 5.0 grams sodium hydroxide (based on the weight of the acrylic acid) with continuous stirring.

### EXAMPLE 2

In a thermostatic three-necked reactor, 50 grams of sodium alginate was dissolved in 2500 ml water at a temperature of 80° C. To this 12.5 g protein hydrolysate (based on the weight of the biopolymer) from proteinous wastes was added and stirred for 10 min. Subsequently, 5 grams sodium metabisulfite (based on the weight of the acrylic acid) was added to the reactor and stirred for 5 min. 500 ml acrylic acid dissolved in 2000 ml water (based on the weight of the acrylic acid) and 10 grams potassium persulfate (based on the weight of the acrylic acid) dissolved in 300 ml water (based on the weight of the potassium persulfate) were added into the reactor simultaneously through two different necks and stirred for 30 min. Finally, the viscous solution was stirred for 30 min. at 60° C. and then at 70° C. for 40 min. The resultant product devoid of monomer smell was cooled to room temperature. The pH of the final product was found to be 4.7.

### EXAMPLE 3

In a thermo static three-necked reactor, 125 grams of starch was dissolved in 2500 ml water at a temperature of 80° C. To this 12.5 g protein hydrolysate (based on the weight of the biopolymer) from proteinous wastes was added and stirred for 10 min. Subsequently, 5 grams sodium metabisulfite (based on the weight of the acrylic acid) was added to the reactor and stirred for 5 min. 500 ml acrylic acid dissolved in 2000 ml water (based on the weight of the acrylic acid) and 10 grams potassium persulfate (based on the weight of the acrylic acid) dissolved in 300 ml water (based on the weight of the potassium persulfate) were added into the reactor simultaneously through two different necks of the reactor and stirred for 30 min. Finally, the viscous solution was stirred for 30 min. at 60° C. and then at 70° C. for 30 min. The resultant product devoid of monomer smell was cooled to room temperature. The product was finally neutralized to a pH 4.5 using 5.0 grams sodium carbonate (based on the weight of the acrylic acid) with continuous stirring.

### EXAMPLE 4

In a thermo static three-necked reactor, 125 grams of carrageenan was dissolved in 2500 ml water at a temperature of 80° C. To this 31.3 g protein hydrolysate (based on the weight of the biopolymer) from proteinous wastes was added and stirred for 10 min. Subsequently, 5 grams sodium metabisulfite (based on the weight of the acrylic acid) was added to the reactor and stirred for 5 min. 500 ml acrylic acid dissolved in 2000 ml water (based on the weight of the acrylic acid) and 10 grams potassium persulfate (based on the weight of the acrylic acid) dissolved in 300 ml water (based on the weight of the potassium persulfate) were added into the reactor simultaneously through two different necks and stirred for 30 min. Finally, the viscous solution was stirred for 30 min. at 60° C. and then at 70° C. for 35 min. The resultant product devoid of monomer smell was cooled to room temperature. The cooled solution was neutralized to a pH 4.5 using 10 grams sodium bicarbonate (based on the weight of the acrylic acid) with continuous stirring.

### EXAMPLE 5

In a thermo static three-necked reactor, 75 grams of carrageenan and 50 grams starch were dissolved in 2500 ml water at a temperature of 80° C. To this 31.3 g protein hydrolysate (based on the weight of the biopolymer) from proteinous wastes was and stirred for 10 min. Subsequently, 5 grams sodium metabisulfite (based on the weight of the acrylic acid) was added to the reactor and stirred for 5 min. 500 ml acrylic acid dissolved in 2000 ml water (based on the weight of the acrylic acid) and 10 grams potassium persulfate (based on the weight of the acrylic acid) dissolved in 300 ml water (based on the weight of the potassium persulfate) were added into the reactor simultaneously through two different necks and stirred for 30 min. Finally, the viscous solution was stirred for 30 min. at 60° C. and then at 70° C for 30 min. The product devoid of monomer smell was finally neutralized to a pH 4.5 using 10 grams sodium bicarbonate (based on the weight of the acrylic acid) with continuous stirring.

### Advantages:

1. Provides improved characteristics such as fibre lubrication, filling of looser ends, softness, shape retention and fabrication comforts to the leather
2. Phenol and formaldehyde free synthetic tanning agents
3. Provides additional binding sites for the improved fixation of dye and fatliquor
4. Less in neutral salt content
5. Product contains biodegradable polymers
6. Provides better light fastness to the leathers
7. Better utilization of natural/waste materials

1. A tanning composition useful for tanning leathers comprising 0.5 to 10% w/v of a biopolymer selected from sodium alginate, starch and carrageenan either alone or in any combination, 10 to 25% w/w of protein hydrolysate, 0.75 to 1.0% w/w of sodium metabisulphite and 10 to 100% v/v of acrylic/methacrylic acid.

2. A composition according to claim 1, wherein the protein hydrolysate may be obtained from sources such as chrome shavings and raw hide trimmings used either alone or in combination.

3. A process for the preparation of the tanning composition according to claim 1, wherein the process steps comprising:
[a] dissolution of the biopolymer in water under continuous stirring until a homogeneous viscous solution is obtained;
[b] simultaneous preparation of protein hydrolysate from proteinous waste materials by subjecting it to alkaline or enzymatic hydrolysis;
[c] blending of biopolymer solution as obtained from step [a] , protein hydrolysate as obtained from step [b] and sodium metabisulphite under continuous stirring along with drop wise addition of acrylic/methacrylic acid and potassium persulphate;
[d] optionally neutralizing the blend as obtained from step [c] to pH 4.5 to 5.0 using alkali to obtain the desired tanning composition.

4. A process according to claim 3, wherein the alkali used is selected from the group consisting of sodium carbonate, sodium bicarbonate and sodium hydroxide.
